(19) United States
(12) Patent Application Publication
(10) Pub. No.: US 2019/0228875 A1
(43) Pub. Date: Jul. 25, 2019

(54) CORD SWITCH

(71) Applicant: Hitachi Metals, Ltd., Tokyo (JP)

(72) Inventors: Keisuke SUGITA, Tokyo (JP); Masahiro ABE, Tokyo (JP)

(21) Appl. No.: 16/184,593

(22) Filed: Nov. 8, 2018

(30) Foreign Application Priority Data
Jan. 24, 2018 (JP) 2018-009614
Feb. 13, 2018 (JP) 2018-022693

(51) Int. Cl. H01B 7/10; H01B 7/00; H01H 3/14

(52) U.S. Cl. CPC H01B 7/104; H01B 13/0264; H01H 3/142; H01B 7/0009

(57) ABSTRACT

A cord switch is composed of a hollow tubular member having elasticity and insulating properties, and a plurality of electrode wires disposed opposite an inner side of the tubular member and spaced apart by elastic force of the tubular member. The plurality of electrode wires each include a conductor formed by stranding a plurality of metal wires together. All of the metal wires constituting the conductors are helically stranded together.

### CROSS-REFERENCE TO RELATED APPLICATIONS

The present application is based on Japanese patent application No. 2018-009614 filed on Jan. 24, 2018 and Japanese patent application No. 2018-022693 filed on Feb. 13, 2018, the entire contents of which are incorporated herein by reference.

### BACKGROUND OF THE INVENTION

### 1. Field of the Invention

The present invention relates to a cord switch.

### 2. Description of the Related Art

A cord switch is conventionally used to prevent a foreign object (e.g., a human body) from being caught in a sliding door or the like of a vehicle (see, e.g., WO2015/194030). In order to prevent a foreign object (e.g., a human body) from being caught in the sliding door of the vehicle, the cord switch is installed along a door edge portion of the sliding door. The so-called “cord switch” is a cord-like sensor switch including a cable and typically used as a pressure-sensitive sensor.

The cord switch described in WO2015/194030 includes a tubular member having elasticity and insulation properties and having a hollow portion formed along a longitudinal direction, and a plurality of electrode wires having a conductor with a plurality of metallic wires stranded together and being provided spaced apart from each other on the inner surface of the tubular member. In this cord switch, when pressure is applied to the tubular member, e.g., by contact with a human body or the like, at least two of the plurality of electrode wires spaced apart from each other are brought into contact. Therefore, by detecting the contact of the electrode wires, it is possible to detect the contact of the human body or the like.

### SUMMARY OF THE INVENTION

Now, it is considered that the cord switch is installed along the door edge portion of the sliding door or the like with a more complicated layout. At that time, it is considered that the cord switch is installed along a curved portion having a smaller bending radius.

However, when the cord switch was installed along a curved portion having a small bending radius as described above, there was the problem that the tubular member buckled. In this case, there is a possibility that the problem occurs that the electrode wires are brought into contact with each other beforehand by the buckling of the tubular member, even though no foreign object (e.g., human body) is in contact with the cord switch.

Accordingly, it is an object of the present invention to provide a cord switch capable of suppressing the buckling of a tubular member.

According to one aspect of the invention, for the purpose of solving the above problem, there is provided a cord switch, comprising: a hollow tubular member having elasticity and insulating properties; and a plurality of electrode wires disposed opposite an inner side of the tubular member and spaced apart by elastic force of the tubular member, wherein the plurality of electrode wires each include a conductor formed by stranding a plurality of metal wires together, wherein all of the metal wires constituting the conductors are helically stranded together.

According to another embodiment of the invention, for the purpose of solving the problem, there is provided a cord switch, comprising: a hollow tubular member having elasticity and insulating properties; and a plurality of electrode wires including a conductor portion and being disposed opposite to an inner side of the tubular member and spaced apart by elastic force of the tubular member, wherein the conductor portions include a linear body and a plurality of conductor wires helically stranded together around an outer circumference of the linear body, wherein the linear bodies are more likely to be extended in a longitudinal direction than each of the plurality of conductor wires.

[Points of the Invention]

According to the present invention, it is possible to provide the cord switch capable of suppressing the buckling of the tubular member.

### BRIEF DESCRIPTION OF THE DRAWINGS

FIG. 1A is a cross sectional view perpendicular to a longitudinal direction showing a cord switch according to a first embodiment of the present invention;

FIG. 1B is a perspective view showing the cord switch according to the first embodiment of the present invention;

FIG. 2A is a cross-sectional view showing an electrode wire used for the cord switch according to the first embodiment of the present invention;

FIG. 2B is an enlarged view of a portion A of FIG. 2A;

FIG. 3 is an explanatory view for explaining a method of producing a conductor used for the cord switch according to the first embodiment of the present invention;

FIG. 4 is a perspective view showing a cord switch according to one modification to the first embodiment of the present invention;

FIG. 5A is a cross-sectional view perpendicular to a longitudinal direction showing a cord switch according to a second embodiment of the present invention;

FIG. 5B is a perspective view showing the cord switch according to the second embodiment of the present invention;

FIG. 6A is a cross-sectional view showing an electrode wire used for the cord switch according to the second embodiment of the present invention; and

FIG. 6B is an enlarged view of a portion A in FIG. 6A.

### DETAILED DESCRIPTION OF THE PREFERRED EMBODIMENTS

### Embodiments

An embodiment of the present invention will be described below with reference to the accompanying drawings.

### First Embodiment

(Whole Configuration of a Cord Switch)

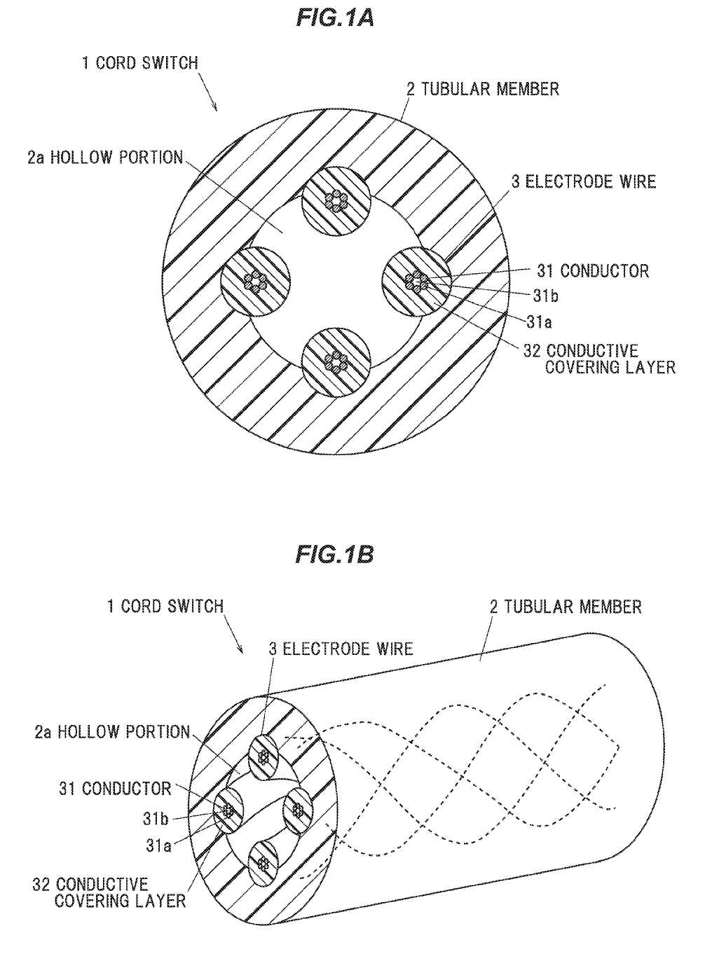

FIG. 1A is a cross sectional view perpendicular to a longitudinal direction showing a cord switch according to a first embodiment of the present invention, and FIG. 1B is a perspective view showing the cord switch according to the first embodiment of the present invention

As shown in FIGS. 1A and 1B, the cord switch 1 includes a hollow tubular member 2 having elasticity and insulation properties, and a plurality of electrode wires 3 arranged opposite to an inner side of the tubular member 2 and spaced apart by elastic force of the tubular member 2.

The tubular member 2 is formed in a cylindrical shape having a hollow portion 2a along the longitudinal direction (in a cylindrical shape with no pressing force being externally applied thereto). The tubular member 2 is desirably made of a material having small compression permanent distortion and excellent in flexibility, cold resistance, water resistance, chemical resistance, weather resistance and the like. Specifically, as the tubular member 2, e.g., a rubber-based composition obtained by crosslinking an ethylene-propylene-diene copolymer or an olefin-based or styrene-based thermoplastic elastomer composition requiring no crosslinking step can be suitably used. The outer diameter of the tubular member 2 is, e.g., 4 mm.

The plurality of electrode wires 3 each have a conductor 31 formed by stranding a plurality of metal wires 31a together and a conductive covering layer 32 covering the outer circumference of the conductor 31. Although FIGS. 1A and 1B show the case where four electrode wires 3 are arranged at an equal pitch in the circumferential direction on the inner surface of the tubular member 2, the number of the electrode wires 3 is not limited to this, but it may be two or more.

In the first embodiment, the plurality of electrode wires 3 are helically arranged on an inner side of the tubular member 2. As a result, even if the cord switch 1 is pressed from any direction, the electrode wires 3 are easily brought into contact with each other, and it is possible to suppress the detection failure of foreign object contact.

The metal wires 31a used for the conductor 31 are made of copper or a copper alloy. The surface of the metal wires 31a may be plated with tin, nickel, silver, zinc or the like for the purpose of enhancing heat resistance. The outer diameter of the metal wires 31a is, e.g., 0.1 mm Details of the conductor 31 will be described later.

As the conductive covering layer 32, one having elasticity and insulating properties is used. Further, as the conductive covering layer 32, similarly to the tubular member 2, one having a small compression permanent distortion and being excellent in flexibility, cold resistance, water resistance, chemical resistance, weather resistance and the like, and high in conductivity and high in adhesion to the elastic insulator is used. As the conductive covering layer 32, it is more preferable to use one obtained by blending a resin used for the tubular member 2 with a conductive filler such as carbon black. In other words, the conductive covering layer 32 and the tubular member 2 are desirably composed of the same main component materials. Specifically, as the conductive covering layer 32, it is preferable to use, e.g., a rubber-based composition obtained by cross-linking ethylene-propylene-diene copolymerization, or an olefin-based or styrene-based thermoplastic elastomer composition requiring no crosslinking step, blended with a conductive filler such as carbon black.

In the cord switch 1, when a pressing force is externally applied, the tubular member 2 is elastically deformed, the hollow portion 2a is collapsed, and the electrode wires 3 are brought into contact with each other. Therefore, by detecting the contact (short circuit) of the electrode wires 3, it is possible to detect that a foreign object such as a human body has touched the cord switch 1.

(Details of Conductor 31)

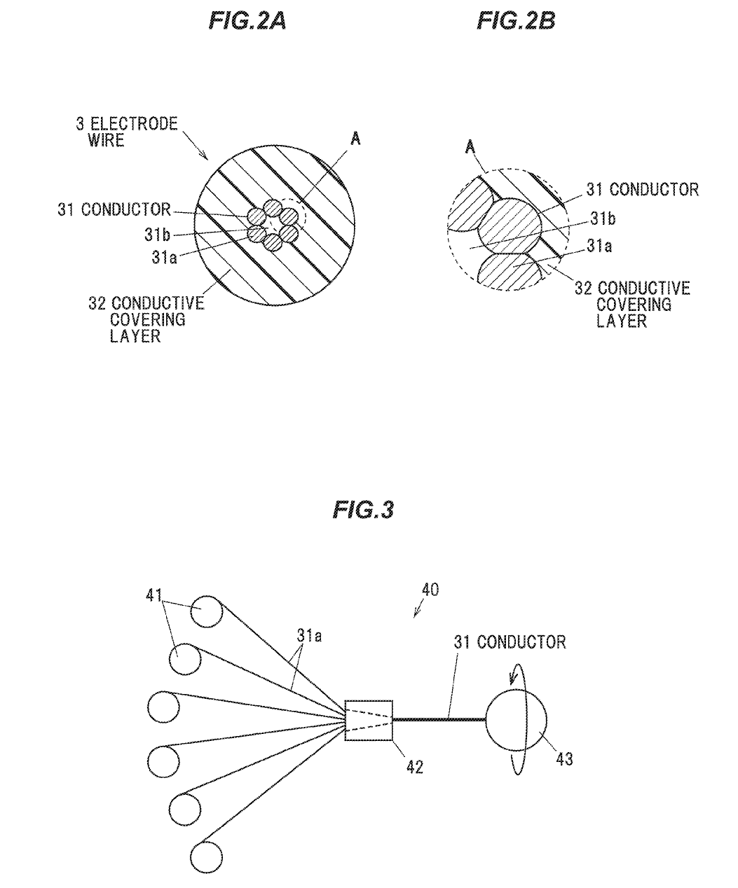

FIG. 2A is a cross-sectional view of the electrode wires 3, and FIG. 2B is an enlarged view of a portion A thereof. In the cord switch 1 according to the first embodiment, all the metal wires 31a constituting the conductor 31 are stranded together in a helical manner. In other words, in the present embodiment, the conductor 31 includes no unstranded metal wires 31a. The reason for this will be described below.

There is known a stranding method called concentric stranding in which a plurality of (e.g., six) metal wires 31a are helically stranded together around one metal wire 31a. In this concentric stranding, no strand is applied to the metal wire 31a disposed at the center, so that it becomes difficult for the conductor 31 to stretch in the longitudinal direction. Therefore, when the conductor 31 is concentrically stranded, when the cord switch 1 is bent at a small bending radius, the conductor 31 cannot follow the elongation of other members, and is subjected to stress of the conductor 31 which is difficult to elongate and the tubular member 2 is easily bent and buckled.

On the other hand, as in the first embodiment, when all the metal wires 31a constituting the conductor 31 are helically stranded together, the conductor 31 is easily extended in the longitudinal direction, and the tubular member 2 also becomes difficult to buckle. In addition, since the conductor 31 acts as a reinforcing material for the tubular member 2 and makes it difficult for the cord switch 1 to be collapsed, no buckling is likely to occur as compared with the case where no conductor 31 is provided.

The conductor 31 may be a stranded conductor formed by so-called collective stranding in which the metal wires 31a are bundled and all of them are stranded together. In the present embodiment, the plurality of metal wires 31a constituting the conductor 31 are arranged in a circumferential direction of the conductor 31 so that the conductor 31 can be more easily extended in the longitudinal direction. In the cross section perpendicular to the longitudinal direction of the conductor 31, the metal wires 31a are each arranged in a circular shape and have a conductor hollow portion 31b formed at the center thereof. The conductor hollow portion 31b surrounded by the metal wires 31a is located at the center of the conductor 31 in the cross section perpendicular to the longitudinal direction of the conductor 31 and is formed so as to extend along the longitudinal direction of the conductor 31. That is, the conductor 31 is formed as a hollow cylindrical shape as a whole. Also, it can be said that the plurality (six) of metal wires 31a are helically stranded together around the outer circumference of the conductor hollow portion 31b. Since the conductor 31 has the conductor hollow portion 31b, even in a case where the cord switch 1 is pressed by a strong force and the electrode wires 3 are brought into contact with each other by the strong force, the conductor hollow portion 31b serves as a cushion and it is possible to suppress damage to the electrode wires 3.

In the first embodiment, the number of the metal wires 31a constituting the conductor 31 is six. That is, in the present embodiment, in the concentric stranding using the seven metal wires 31a, the metal wire 31a arranged at the center is omitted. As the number of metal wires 31a is decreased, the diameter of the helix when stranding the metal wires 31a together is decreased and the conductor 31 does not easily extend in the longitudinal direction, so it is desirable that the number of the metal wires 31a constituting the conductor 31 be six or more.

In addition, if the strand pitch of the metal wires 31a of the conductor 31 is too long, the conductor 31 is difficult to be extended in the longitudinal direction. The stranding pitch of the metal wires 31a in the conductor 31 is preferably at least smaller than the strand pitch (helical pitch) of the electrode wires 3. Note that the strand pitch of the conductor 31 is the distance along the longitudinal direction of the conductor 31 until any conductor 31 makes one turn in the circumferential direction of the conductor 31 from a certain position in the circumferential direction and returns to that position. In addition, the strand pitch of the electrode wires 3 is the distance along the longitudinal direction of the cord switch 1 until any electrode wire 3 makes one turn in the circumferential direction of the cord switch 1 from a certain position in the circumferential direction and returns to that position. The strand pitch of the electrode wires 3 is larger than the strand pitch of the metal wires 31a, and is e.g., 10.0 mm. The strand pitch of the metal wires 31a is, e.g., 3.0 mm.

In addition, it is desirable that the helical winding direction of the plurality of electrode wires 3 and the stranding direction of the metal wires 31a of the conductor 31 be opposite directions. This is because when the helical winding direction of the electrode wires 3 and the stranding direction of the metal wires 31a of the conductor 31 are in the same directions, undulation (kink) tends to occur in the cord switch 1 due to the returning force of the strand. In other words, by setting the helical winding direction of the electrode wires 3 and the stranding direction of the metal wires 31a of the conductor 31 in the opposite directions, it is easy to obtain the linear cord switch 1 with less undulation (kink).

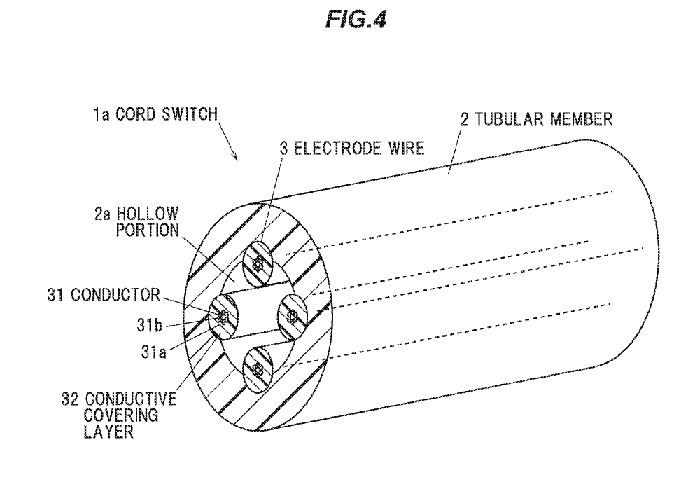

When producing the conductor 31, a stranded wire producing apparatus 40 as shown in FIG. 3 is used, the six metal wires 31a are each extended from a wire bobbin 41, and passed through a die 42, and the conductor 31 passed through the die 42 is wound around a drum 43. By winding up while rotating the drum 43, the metal wires 31a can be stranded together.

The six metal wires 31 a are arranged in a circular shape (cylindrical shape) in the die 42. The inside of the die 42 is gradually reduced in diameter from the inlet side to the outlet side, and the diameter of the outlet of the die 42 is slightly smaller than the outside diameter when the six metallic wires 31a are arranged in the circular shape. As a result, as shown in FIG. 2B, each metal wire 31a is pushed inward in the radial direction to be slightly collapsed, and the metal wires 31a are unlikely to be unraveled, and the conductor 31 is held in the cylindrical shape. That is, in the present embodiment, the metal wires 31a are each slightly deformed from the circular shape before being stranded together, and the metal wires 31a adjacent to each other in the circumferential direction of the conductor 31 are pressed against each other and are in contact with each other in the plane.

Note that in this embodiment, since the electrode wires 3 are helically arranged, when the cord switch 1 is bent, the electrode wires 3 are deformed in such a manner that the strand pitch of the electrode wires 3 becomes narrow on the inner side of the bend while the strand pitch of the electrode wires 3 becomes wide on the outer side of the bend, as when bending a spring. Therefore, in the cord switch 1 in which the electrode wires 3 are arranged in the helical shape, there is a case in which even if the elongation of the conductor 31 is small, it can sufficiently follow the bending. However, this property appears when the strand pitch of the electrode wires 3 is sufficiently short, but when the strand pitch of the electrode wires 3 is long, if the elongation of the conductor 31 is small, the buckling tends to occur.

In addition, when the strand pitch of the electrode wires 3 is shortened, the electrode wires 3 included in the unit length of the cord switch 1 becomes long, resulting in an increase in cost. Therefore, it is desired to make the strand pitch of the electrode wires 3 as long as possible to reduce the cost. By helically stranding all the metal wires 31a constituting the conductor 31 together as in the present embodiment, even in the case where the strand pitch of the electrode wires 3 is increased for cost reduction, it is possible to realize the cord switch 1 which is difficult to buckle.

(Modifications)

Although in the first embodiment, the case where the electrode wires 3 are helically arranged on the inner side of the tubular member 2 has been described, as in a cord switch 1a shown in FIG. 4, the electrode wires 3 may be arranged linearly along the longitudinal direction on the inner side of the tubular member 2. Compared to the cord switch 1 in which the electrode wires 3 are helically arranged, the cord switch 1a has an advantage that it is easy to produce and is low in cost. However, in the cord switch 1a, in order to suppress buckling when bending is applied, it is necessary that the electrode wires 3 arranged on the outer side of the bend are sufficiently elongated in the longitudinal direction. Therefore, by applying the present invention, all of the metal wires 31a constituting the conductor 31 are helically stranded together, so that it is possible to sufficiently extend the electrode wires 3 in the longitudinal direction and it is possible to suppress the buckling of the tubular member 2.

### Operation and Advantageous Effects of the First Embodiment

As described above, in the cord switch 1 according to the first embodiment, all the metal wires 31a constituting the conductor 31 of the electrode wires 3 are helically stranded together. This makes it easier for the conductor 31 to be extended in the longitudinal direction, so that it is possible to suppress the buckling of the tubular member 2 even when the cord switch 1 is bent at a small bending radius, and it is possible to realize the code switch 1 excellent in allowable bendability. As a result, it is possible to realize the cord switch 1 that can also cope with a more complicated layout.

### Second Embodiment

(Overall Configuration of a Cord Switch)

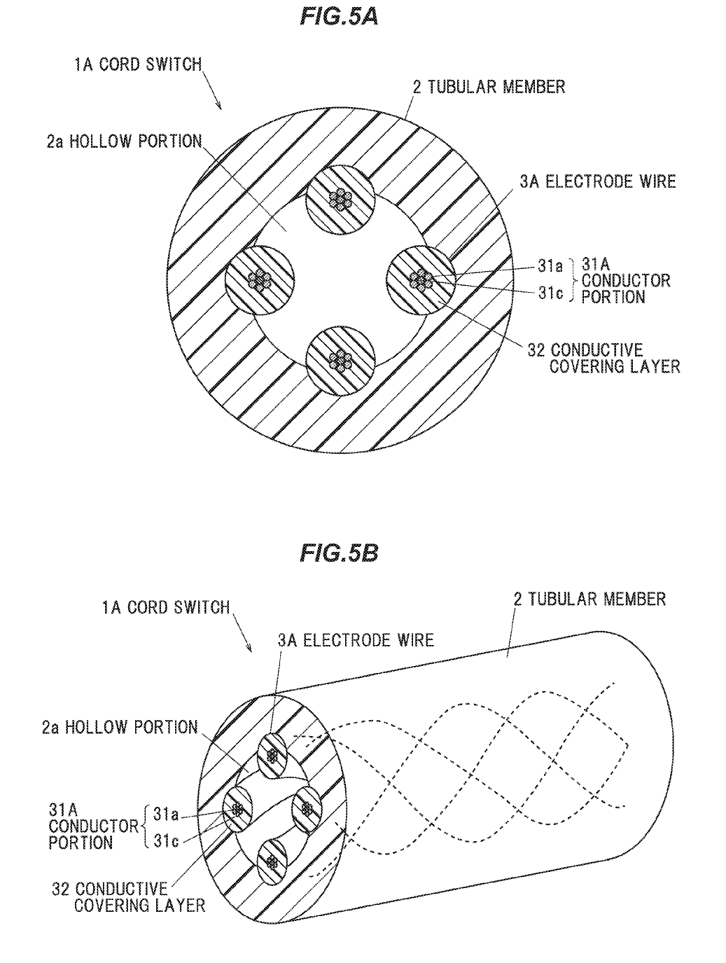

FIG. 5A is a cross-sectional view perpendicular to a longitudinal direction showing a cord switch according to a second embodiment of the present invention, and FIG. 5B is a perspective view showing the cord switch according to the second embodiment of the present invention

As shown in FIGS. 5A and 5B, the cord switch 1A includes a hollow tubular member 2 having elasticity and insulation properties, and a plurality of electrode wires 3A arranged opposite to an inner side of the tubular member 2 and spaced apart by elastic force of the tubular member 2. The cord switch 1A according to the second embodiment is different from the cord switch 1 according to the first embodiment in that the electrode wires 3A are provided with a linear body 31c instead of the conductor hollow portion 31b of the electrode wires 3. In the description relating to the second embodiment, the same reference numerals are used for the elements exhibiting the same operation and advantageous effects as those of the first embodiment, and detailed descriptions thereof will be omitted.

The tubular member 2 is the same as that of the first embodiment, and a detailed description thereof will be omitted.

Each of the plurality of electrode wires 3A has a conductor portion 31A and a conductive covering layer 32 covering the outer circumference of the conductor portion 31A.

Each of the conductor portions 31A of the plurality of electrode wires 3A includes the linear body 31c arranged at the center of the conductor portion 31A and extending in the longitudinal direction of the cord switch 1A and a plurality of conductor wires 31a helically stranded together around the outer circumference of the linear body 31c. Although FIGS. 5A and 5B show the case where four electrode wires 3A are arranged at an equal pitch in the circumferential direction on the inner surface of the tubular member 2, the number of the electrode wires 3A is not limited to this, but it may be two or more.

In the second embodiment, the plurality of electrode wires 3A are helically arranged on the inner side of the tubular member 2. As a result, even when the cord switch 1A is pressed from any direction, the electrode wires 3A are easily brought into contact with each other, and it is possible to suppress the detection failure of foreign object contact.

The conductor wires 31a used for the conductor portion 31A are the same as those of the first embodiment. Details of the conductor portion 31A will be described later.

The conductive covering layer 32 is the same as in the first embodiment.

Even in the cord switch 1A, when a pressing force is externally applied, the tubular member 2 is elastically deformed, and the hollow portion 2a is collapsed, and the electrode wires 3A are brought into contact with each other. Therefore, by detecting the contact (short circuit) of the electrode wires 3A, it is possible to detect that a foreign object such as a human body has touched the cord switch 1A.

(Details of the Conductor Portion 31A)

FIG. 5A is a cross-sectional view of the electrode wires 3A, and FIG. 5B is an enlarged view of a portion A thereof. In the cord switch 1A according to the second embodiment, the linear body 31c disposed at the center of the conductor portion 31A is more likely to be extended in the longitudinal direction than each of the plurality of conductor wires 31a. The phrase “the linear body 31c is more likely to be extended in the longitudinal direction than each of the plurality of conductor wires 31a” means that the elongation at the time of grasping both ends of the substantially straight linear body 31c and pulling it in the longitudinal direction (at the same tensile force as when pulling the conductor wires 31a) is longer than the elongation when both ends of the unhelical but substantially straight conductor wires 31a are gripped and pulled in the longitudinal direction. Further, in the second embodiment, all of the conductor wires 31a constituting the conductor portion 31A are helically stranded together around the outer circumference of the linear body 31c. In other words, in the present embodiment, no unstranded conductor wire 31a is included in the conductor portion 31A. The reason for this will be explained below.

As described in the explanation of the first embodiment, in the concentric stranding, no strand is applied to the conductor wire 31a arranged at the center, so that the conductor portion 31A is difficult to be extended in the longitudinal direction. Therefore, in the case where the conductor portion 31A is concentrically stranded, when the cord switch 1A is bent at a small bending radius, the conductor portion 31A cannot follow the elongation of other members, and is subjected to the stress of the conductor portion 31A which is difficult to elongate and the tubular member 2 is easily bent and buckled.

On the other hand, in the second embodiment, the linear body 31c disposed at the center of the conductor portion 31A is configured in such a manner as to be more likely to be extended in the longitudinal direction than the conductor wires 31a. In addition, all the conductor wires 31a constituting the conductor portion 31A are configured in such a manner as to be helically stranded together around the outer circumference of the linear body 31c. This makes it easier for the conductor portion 31A to be extended in the longitudinal direction, so that the tubular member 2 is also difficult to buckle. Furthermore, since the conductor portion 31A acts as a reinforcing material for the tubular member 2 to make it difficult for the cord switch 1A to be collapsed, no buckling is likely to occur as compared with the case where no conductor portion 31A is provided.

The linear body 31c is preferably made of, e.g. a substance having a smaller Young's modulus than that of each of the plurality of conductor wires 31a. As that substance, it is preferable to use at least one of rubber, Teflon (registered trademark), polypropylene, polystyrene, and nylon. Further, the linear body 31c may be a stranded body in which a plurality of wires are stranded together. As that stranded body, stranded yarns made of natural fibers and chemical fibers, or conductor stranded wires made of a plurality of conductor wires can be used.

Also in the second embodiment, the number of conductor wires 31a constituting the conductor portion 31A is six. That is, in the second embodiment, in the concentric stranding using the seven conductor wires 31a, the linear body 31c is used in place of the conductor wire 31a arranged at the center.

The strand pitch of the conductor wires 31a in the conductor portion 31A is the same as in the first embodiment.

In addition, the winding direction of the helix of the plurality of electrode wires 3A and the stranding direction of the conductor wires 31a of the conductor portion 31A are also the same as in the first embodiment.

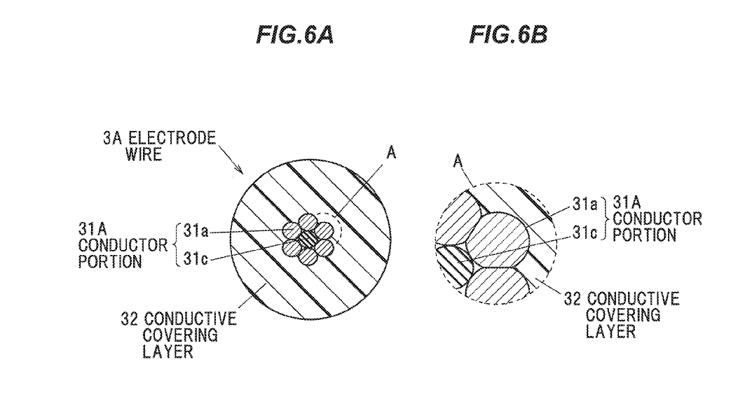

Further, as shown in FIG. 6B, through the producing step such as the stranding together of the conductor wires 31a at the time of producing the cord switch 1A, the conductor wires 31a are each pressed radially inward and slightly collapsed. That is, in the present embodiment, the conductor wires 31a are each slightly deformed from the circular shape before being stranded together, and the conductor wires 31a adjacent to each other in the circumferential direction of the conductor portion 31A are pressed against each other and are in contact with each other in the plane.

Note that in the second embodiment as well, since the electrode wires 3A are arranged in the helical shape, when the cord switch 1A is bent, the electrode wires 3A is deformed in such a manner that the strand pitch of the electrode wires 3A is narrow on the inner side of the bend while the strand pitch of the electrode wires 3A becomes wide on the outer side of the bend, as when bending a spring. Therefore, in the cord switch 1A in which the electrode wires 3A are arranged in the helical shape, there is a case where the conductor portion 31A can sufficiently follow the bending even if the elongation of the conductor portion 31A is small. However, such a characteristic appears when the strand pitch of the electrode wires 3A is sufficiently short, but when the strand pitch of the electrode wires 3A is long, if the extension of the conductor portion 31A is small, the buckling tends to occur.

Also, when the strand pitch of the electrode wires 3A is shortened, the electrode wires 3A included in the unit length of the cord switch 1A becomes long, resulting in an increase in cost. Therefore, it is desired to make the strand pitch of the electrode wires 3A as long as possible to reduce the cost. As in the present embodiment, the linear body 31c arranged at the center of the conductor portion 31A is more likely to be extended in the longitudinal direction than each of the plurality of conductor wires 31a and all the conductor wires 31a constituting the conductor portion 31A are helically stranded together, so that even in the case where the strand pitch of the electrode wires 3A is increased for cost reduction, it is possible to realize the cord switch 1 which is unlikely to buckle.

(Modifications)

Although in the second embodiment as well, the case where the electrode wires 3A are helically arranged on the inner side of the tubular member 2 has been described, it is also possible to arrange the electrode wires in a linear shape along the longitudinal direction on the inner side of the tubular member. The cord switch of this modified example has an advantage that it is easier to produce and less expensive than the above described cord switch 1A in which the electrode wires 3A are helically arranged. However, in this cord switch of this modification, in order to suppress buckling when bending is applied, it is necessary that the electrode wires arranged on the outer side of the bend are sufficiently stretched in the longitudinal direction. Therefore, by applying the present invention, the linear body arranged at the center of the conductor portion is more likely to be extended in the longitudinal direction than each of the plurality of conductor wires, and all the conductor wires constituting the conductor portion are helically stranded together, so that the electrode wires can be stretched sufficiently in the longitudinal direction and the buckling of the tubular member can be suppressed.

### Operation and Advantageous Effects of the Second Embodiment

As described above, in the cord switch 1A according to the second embodiment, the linear body 31c disposed at the center of the conductor portion 31A is more likely to be extended in the longitudinal direction than each of the plurality of conductor wires 31a, and the conductor wires 31a constituting the conductor portion 31A of the electrode wires 3A are helically stranded together around the outer circumference of the linear body 31c. This makes it easier for the conductor portion 31A to be extended in the longitudinal direction, so that even when the cord switch 1A is bent at a small bending radius, the buckling of the tubular member 2 can be suppressed, and the cord switch 1A excellent in allowable bendability can be realized. As a result, it is possible to realize the cord switch 1A that can cope with a more complicated layout as well.

### SUMMARY OF THE EMBODIMENT

Next, the technical ideas grasped from the above-described embodiments will be described with the aid of reference numerals and the like in the embodiments. It should be noted, however, that each of the reference numerals and the like in the following description does not limit the constituent elements in the claims to the members and the like specifically shown in the embodiments.

[1] A cord switch (1), comprising: a hollow tubular member (2) having elasticity and insulating properties; and a plurality of electrode wires (3) disposed opposite an inner side of the tubular member (2) and spaced apart by elastic force of the tubular member (2), wherein the plurality of electrode wires (3) each include a conductor (31) formed by stranding a plurality of metal wires (31a) together, wherein all of the metal wires (31a) constituting the conductors (31) are helically stranded together.

[2] The cord switch (1) according to [1] above, wherein the plurality of metal wires (31a) constituting the conductors (31) are aligned in a circumferential direction of the conductors (31) and are formed with a conductor hollow portion (31b) surrounded by the metal wires (31a) and extending along a longitudinal direction of the conductors (31).

[3] The cord switch (1) according to [2] above, wherein the number of the metal wires (31a) constituting the one conductor (31) is six or more.

[4] The cord switch (1) according to any one of [1] to [3] above, wherein the plurality of electrode wires (3) are helically arranged on an inner side of the tubular member (2), wherein a winding direction of the helix of the plurality of electrode wires (3) and a stranding direction of the metal wires (31a) of the conductors (31) are opposite directions.

[5] The cord switch (1) according to any one of [1] to [4] above, wherein the outer circumferences of the conductors (31) are covered with a conductive covering layer (32).

[6] The cord switch (1) according to [5] above, wherein the conductive covering layer (32) is formed of a rubber composition or a thermoplastic elastomer composition blended with a conductive filler.

[7] A cord switch (1A), comprising: a hollow tubular member (2) having elasticity and insulating properties; and a plurality of electrode wires (3A) including a conductor portion (31A) and being disposed opposite to an inner side of the tubular member (2) and spaced apart by elastic force of the tubular member (2), wherein the conductor portions (31A) include a linear body (31c) and a plurality of conductor wires (31a) helically stranded together around an outer circumference of the linear body (31c), wherein the linear bodies (31c) are more likely to be extended in a longitudinal direction than each of the plurality of conductor wires (31a).

[8] The cord switch (1A) according to [7] above, wherein the linear bodies (31c) are made of a substance having a Young's modulus smaller than that of each of the plurality of conductor wires (31a).

[9] The cord switch (1A) according to [8] above, wherein the linear bodies (31c) are made of at least one of rubber, Teflon (registered trademark), polyethylene, polypropylene, polystyrene, and nylon.

[10] The cord switch (1A) according to [7] above, wherein the linear bodies (31c) are composed of a stranded body with a plurality of wires stranded together.

[11] The cord switch (1A) according to any one of [7] to [10] above, wherein the outer circumferences of the conductor portions (31A) are covered with a conductive covering layer (32).

[12] The cord switch (1A) according to [10] above, wherein the conductive covering layers (32) are composed of a rubber composition or a thermoplastic elastomer composition blended with a conductive filler.

Although the embodiment of the present invention has been described above, the embodiment described above does not limit the invention according to the claims. It should also be noted that not all combinations of the features described in the embodiments are indispensable to the means for solving the problem of the invention. Further, the present invention can be appropriately modified and carried out within the scope not deviating from the spirit thereof.

What is claimed is:

1. A cord switch, comprising:
a hollow tubular member having elasticity and insulating properties; and
a plurality of electrode wires disposed opposite an inner side of the tubular member and spaced apart by elastic force of the tubular member,
wherein the plurality of electrode wires each include a conductor formed by stranding a plurality of metal wires together,
wherein all of the metal wires constituting the conductors are helically stranded together.

2. The cord switch according to claim 1, wherein the plurality of metal wires constituting the conductors are aligned in a circumferential direction of the conductors and are formed with a conductor hollow portion surrounded by the metal wires and extending along a longitudinal direction of the conductors.

3. The cord switch according to claim 2, wherein the number of the metal wires constituting the one conductor is six or more.

4. The cord switch according to claim 1, wherein the plurality of electrode wires are helically arranged on an inner side of the tubular member,
wherein a winding direction of the helix of the plurality of electrode wires and a stranding direction of the metal wires of the conductors are opposite directions.

5. The cord switch according to claim 1, wherein the outer circumferences of the conductors are covered with a conductive covering layer.

6. The cord switch according to claim 5, wherein the conductive covering layer is formed of a rubber composition or a thermoplastic elastomer composition blended with a conductive filler.

7. A cord switch, comprising:
a hollow tubular member having elasticity and insulating properties; and
a plurality of electrode wires including a conductor portion and being disposed opposite to an inner side of the tubular member and spaced apart by elastic force of the tubular member,
wherein the conductor portions include a linear body and a plurality of conductor wires helically stranded together around an outer circumference of the linear body,
wherein the linear bodies are more likely to be extended in a longitudinal direction than each of the plurality of conductor wires.

8. The cord switch according to claim 7, wherein the linear bodies are made of a substance having a Young's modulus smaller than that of each of the plurality of conductor wires.

9. The cord switch according to claim 8, wherein the linear bodies are made of at least one of rubber, Teflon (registered trademark), polyethylene, polypropylene, polystyrene, and nylon.

10. The cord switch according to claim 7, wherein the linear bodies are composed of a stranded body with a plurality of wires stranded together.

11. The cord switch according to claim 7, wherein the outer circumferences of the conductor portions are covered with a conductive covering layer.

12. The cord switch according to claim 11, wherein the conductive covering layers are composed of a rubber composition or a thermoplastic elastomer composition blended with a conductive filler.
